(19) United States
(12) Patent Application Publication
(10) Pub. No.: US 2003/0201860 A1
(43) Pub. Date: Oct. 30, 2003

(54) Ferrite sleeve base with drum core for SMT inductors

(76) Inventor: I-Wen Yang, Taipei Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/128,486

(22) Filed: Apr. 24, 2002

(51) Int. Cl. H01F 27/06

(52) U.S. Cl. 336/65

(57) ABSTRACT

A prismatic sleeve is made of a magnetic material and has a receiving area defined therein. At least two contacting portions are formed on a bottom face of the prismatic sleeve and on opposite sides of the receiving area. The drum core is received in the receiving area and has a coil winding area for winding a coil having two distal ends which are electrically connected to the at least two contacting portions.

### BACKGROUND OF THE INVENTION

1. Field of the Invention

The present invention relates to a ferrite sleeve base and a drum core, and more particularly to a ferrite sleeve base and a drum core for SMT inductors. A base made of a magnetic material has two integrally formed contacts and a drum core mounted in the receiving space in the base so as to delete the requirement of a magnetic ring so as to reduce the cost for production and to enhance the inductance performance.

2. Description of Related Art

With reference to FIG. 6, a conventional combination 9 of a round sleeve and a drum core is shown. The combination 9 has a rectangular base 91 made of a plastic or ceramic material, a magnetic ring 93 and a drum core 95 on the center of the base 91 and two metallic feet 92 extending out of the base 91 in two different directions relative to each other. The drum core 95 has a coil winding recess 951 for winding the coil 97 whose two distal ends are respectively mounted to a respective one of the two metallic feet 92.

The production of the base 91, the magnetic ring 93 and the metallic feet 92 have to be made separately. Especially, the metallic feet 72 need to be mounted on two different places on the base 91, which is very labor inefficient and cost ineffective. Furthermore, the dimension of the SMT inductor is very small, the production of the inductor is quite difficult and therefore, the inductance of the inductor is not easy to be upgraded. Still, nowadays, the electronic components have a trend to be designed small and light weight. However, this conventional SMT inductor is comparatively high and causes positioning problem to the magnetic ring 93 and the drum core 95. The two distal ends of the coil 97 respectively mounted on two different places on the base 91 experience bad connection due to ineffective positioning effect provided to the coil 97.

To overcome the shortcomings, the present invention intends to provide an improved SMT inductor to mitigate or obviate the aforementioned problems.

### SUMMARY OF THE INVENTION

The primary objective of the invention is to provide a ferrite sleeve base with a drum core for a SMT inductor. The base has a receiving space defined to receive therein the drum core and two contacts integrally formed with the base so as to simplify the structure and reduce the cost for manufacture.

Another objective of the invention is to provide a ferrite sleeve base with a drum core for a SMT inductor. The two contacts are integrally formed on two opposite positions on the base so as to enhance the inductance performance.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the present invention;

FIG. 2 is an exploded perspective view of the present invention;

FIG. 3 is a schematic view showing the drum core with a coil mounted therearound;

FIG. 4 is a schematic view of the application of the present invention;

FIG. 5 is a schematic view showing that the present invention is applied to a circuit board; and

FIG. 6 is a perspective view of a conventional structure.

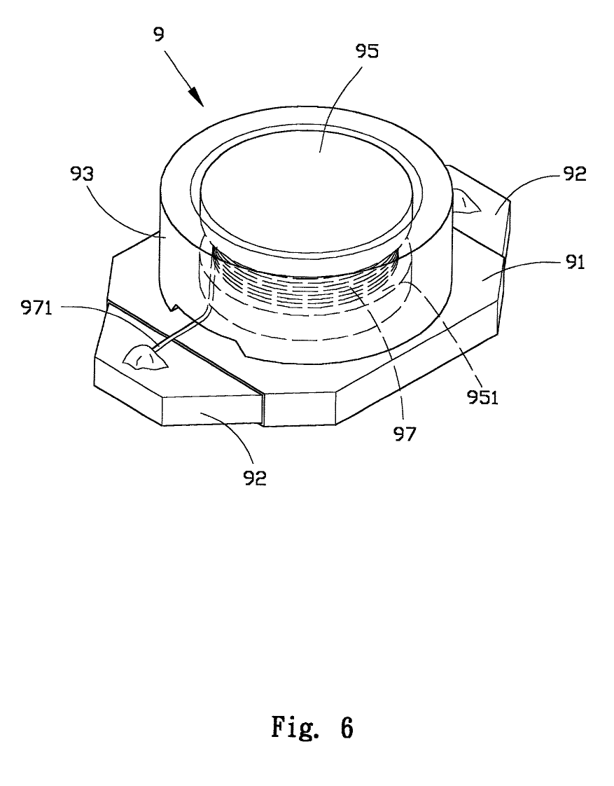

### DETAILED DESCRIPTION OF PREFERRED EMBODIMENT

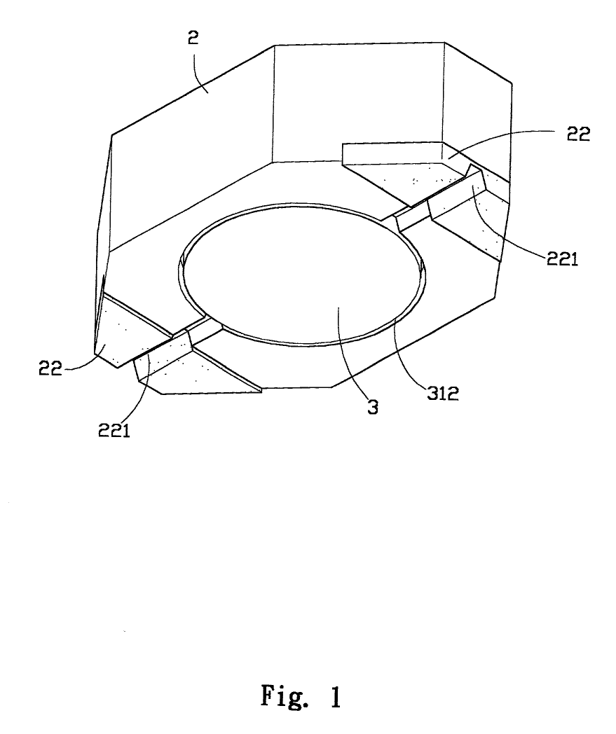

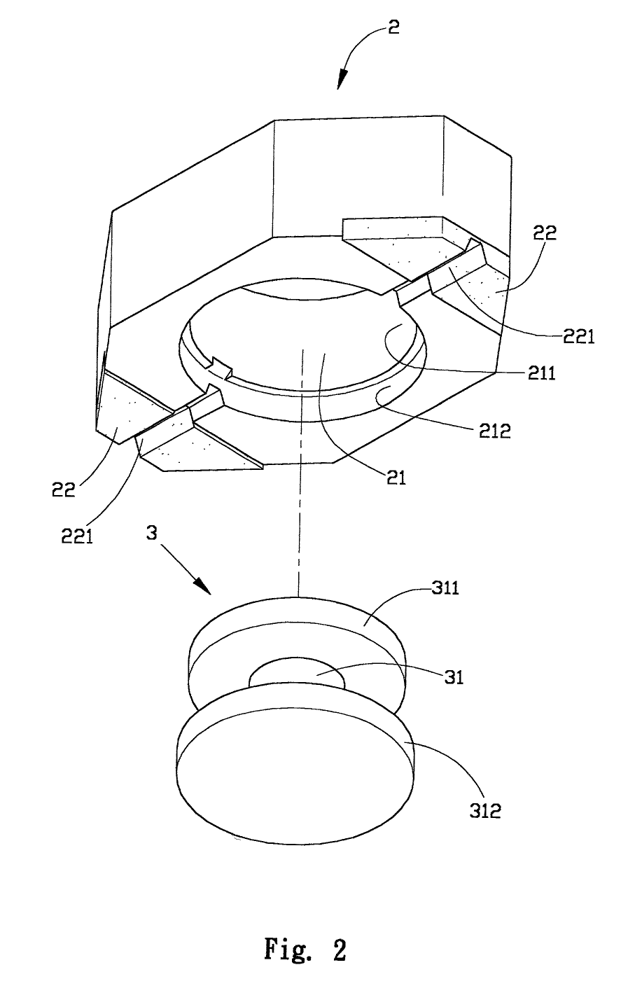

With reference to FIG. 1 and FIG. 2, the SMT inductor of the present invention has a base 2 made of a ferrite material and having a predetermined dimension. The base 2 has a receiving space 21. The receiving space 21 is a circular through hole in this preferred embodiment. The base 2 further has two contacts 22 integrally formed on a bottom face of the base 2 and on opposite sides of the base 2. The two contacts 22 are treated with metalized process.

A drum core 3 is received in the receiving space 21 and has a coil winding recess 31 defined for winding the coil 1 whose two distal ends 11 are respectively and electrically connected to a corresponding one of the two contacts 22. In the embodiment, each of the contacts 22 has a guiding recess 221 defined to extend to the receiving space 21.

The receiving space (circular through hole) 21 is composed of a first through hole 211 and a second through hole 212 coaxial with the first through hole 211 and having a diameter larger than that of the first through hole 211. The drum core 3 is configured to have a small diameter portion 311 and a large diameter portion 312 respectively corresponding to the first and the second through holes 211,212. The larger diameter portion 312 and the small diameter portion 311 are connected with each other by the coil winding recess 31. When the drum core 3 is to be mounted in the receiving space 21 of the base 2, the small diameter portion 311 is received in the first through hole 211 and the large diameter portion 312 is received in the second through hole 212.

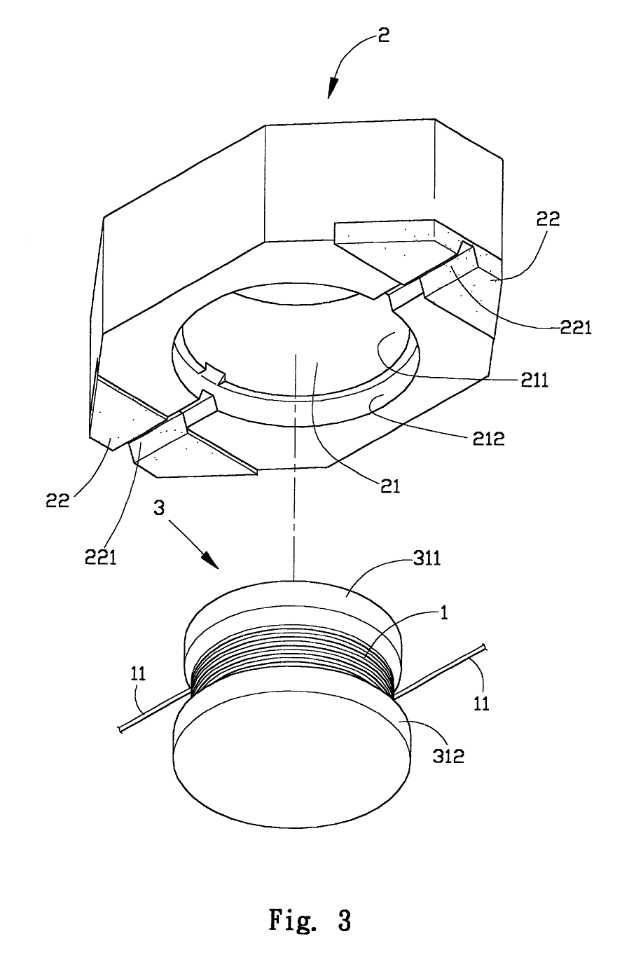

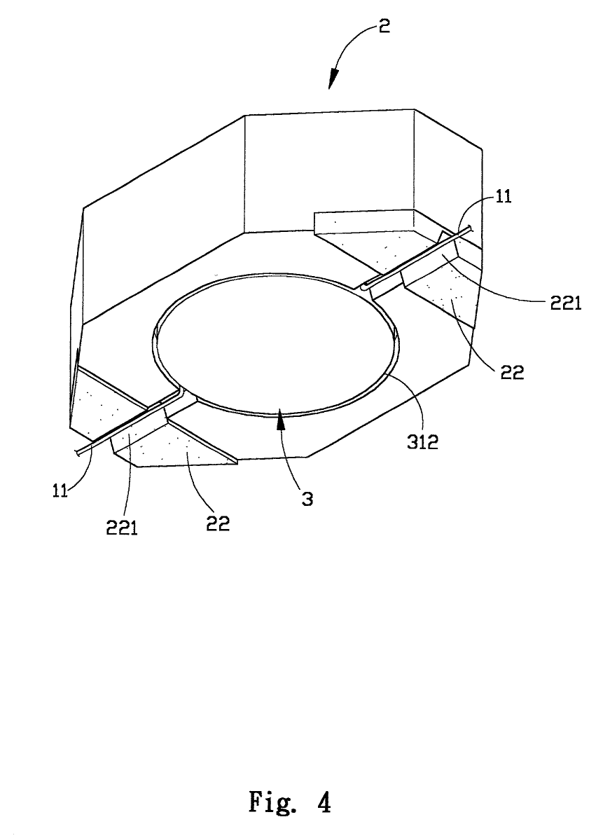

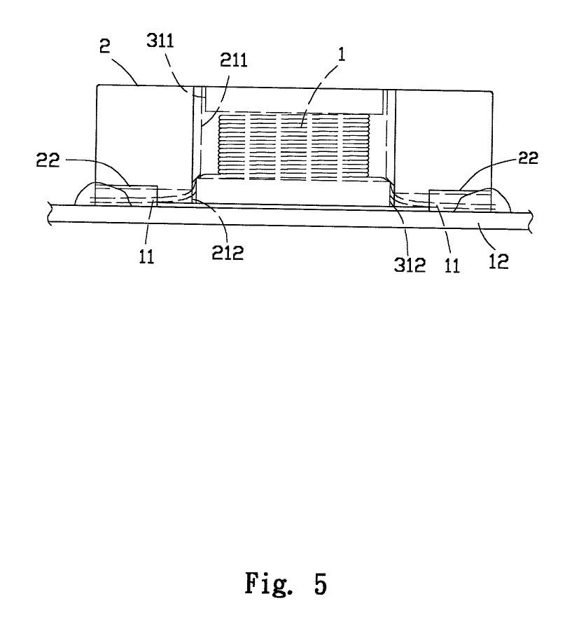

With reference to FIGS. 3 to 5, when the assembly of the present invention is necessary, the coil 1 is wound around the coil winding recess 31. The two distal ends of the coil 1 are respectively received in a corresponding one of the two guiding recesses 221 and contacted with a corresponding one of the two contacts 22. Thereafter, the drum core 3 is received in the receiving space 21 of the base 2 and the two contacts 22 are contacted to a circuit board 12 to allow an electrical connection between the two contacts 22 and the circuit board 12.

With such an arrangement, the conventional magnetic ring is deleted, such that the construction of the inductor of the present invention is easy and thus the height is reduced. Because the drum core 3 is received in the receiving space 21 of the base 2, loose connection between the drum core 3 and the base 2 is avoided.

Further, because the base 2 is made of a magnetic material such that when the inductor is in use, the inductance performance is greater than the conventional one.

In conclusion, the inductor is able to reduce its dimension, which is quite useful when engaged with the circuit board, and to increase its inductance performance when mounted on a circuit board.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a SMT inductor having a ferrite sleeve base and a drum core, the ferrite sleeve base having two contacts respectively provided on two opposite sides of the base and the drum core having a coil winding recess defined for winding therearound a coil whose two distal ends are electrically connected to a corresponding one of the two contacts, wherein the ferrite sleeve base has a receiving space defined therein, at least two contacting portions are formed on a bottom face of the prismatic sleeve and on opposite sides of the receiving space, and the drum core is received in the receiving space and has a coil winding area for winding a coil having two distal ends which are electrically connected to the at least two contacting portions, wherein the improvements comprise:
the ferrite sleeve base is made of a magnetic material,
the at least two contacting portions are integrally formed on a bottom face of the ferrite sleeve base, and the receiving space is defined to receive therein the drum core.

2. The SMT inductor as claimed in claim 1, wherein each of the at least two contacting portions has at least one guiding recess extending toward the receiving area to receive two distal ends of the coil.

3. The SMT inductor as claimed in claim 1, wherein the at least two contacting portions are formed on the ferrite sleeve base by metalized process.

4. The SMT inductor as claimed in claim 1, wherein the receiving space is a through hole.

5. The SMT inductor as claimed in claim 1, wherein the receiving space is composed of a first through hole and a second through hole coaxial with the first through hole and having a diameter larger than that of the first through hole, and
the drum core is configured to have a small diameter portion and a large diameter portion respectively corresponding to the first and the second through holes.
